(19) United States
(12) Patent Application Publication
(10) Pub. No.: US 2026/0127251 A1
(43) Pub. Date: May 7, 2026

(54) ROLLBACK-SECURE ACCOUNTABLE REVOCATION OF FEATURES

(71) Applicant: QUALCOMM Incorporated, San Diego, CA (US)

(72) Inventors: Joona Verneri KANNISTO, Salo (FI); Marcel SELHORST, Zeuthen (DE)

(21) Appl. No.: 18/939,259

(22) Filed: Nov. 6, 2024

(51) Int. Cl. G06F 21/10

(52) U.S. Cl. CPC G06F 21/1076; G06F 21/105

(57) ABSTRACT

Techniques and systems are provided for feature distribution. For instance, a process can include obtaining a downgrade license for a set of features for an apparatus, wherein the downgrade license enables fewer features as compared to a previous license; incrementing a non-volatile rollback counter based on the downgrade license; digitally signing the downgrade license and a value of the non-volatile rollback counter using a key to generate a digital signature; outputting the digital signature for transmission to a license server; and limiting features of the apparatus based on the downgrade license.

### FIELD

The present application is related to feature distribution. For example, aspects of the present application relate to systems and techniques for a rollback secure accountable revocation of features.

### BACKGROUND

Device components may be shipped with a set of features to original equipment manufacturers (OEM) (e.g., reseller, device manufacturer, component integrator, etc.) which may incorporate device components into a device, such as a mobile phone, computer, laptop, vehicle entertainment system, extended reality (XR) device, etc. While the device component includes a set of features, the OEM may not enable all of the features of the set of features. For example, the OEM may purchase a single type of device component and incorporate that same device component into multiple OEM product lines. These multiple product lines may be differentiated by enabling or disabling (e.g., not using, not enabling) certain features of the device component, or certain features may be enabled/disabled based on usage (e.g., radio bands for different countries, etc.).

The device component manufacturer may support enabling/disabling of features of the device component. For example, it may be more cost effective to manufacture a single configuration of the device component and allow OEMs to select which features to enable as compared to manufacturing many versions of the device component. It may also be useful to offer different prices for the device component based on the features enabled. To offer flexibility for the OEM, it may be useful to sell the device component at a single price and then rebate the OEM based on features that were enabled/disabled by the OEM and/or the user. Alternatively, once purchased, it may be useful to allow an end-user may be able to activate features that may not have been enabled by the OEM.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for feature distribution are provided. In one illustrative example, an apparatus for feature distribution is provided. The apparatus includes: at least one memory; a non-volatile rollback counter; and at least one processor coupled to the at least one memory, the at least one processor being configured to: obtain a downgrade license for a set of features for the apparatus, wherein the downgrade license does not include a feature included in a previous license; increment the non-volatile rollback counter based on the downgrade license; digitally sign the downgrade license and a value of the non-volatile rollback counter using a key to generate a digital signature; output the digital signature for transmission to a license server; and limit features of the apparatus based on the downgrade license.

As another example, a method for feature distribution is provided. The method includes: obtaining a downgrade license for a set of features for an apparatus, wherein the downgrade license enables fewer features as compared to a previous license; incrementing a non-volatile rollback counter based on the downgrade license; digitally signing the downgrade license and a value of the non-volatile rollback counter using a key to generate a digital signature; outputting the digital signature for transmission to a license server; and limiting features of the apparatus based on the downgrade license.

In another example, a non-transitory computer-readable medium of an apparatus having stored thereon instructions is provided. The instructions, when executed by at least one processor, cause the at least one processor to: obtain a downgrade license for a set of features for the apparatus, wherein the downgrade license does not include a feature included in a previous license; increment the non-volatile rollback counter based on the downgrade license; digitally sign the downgrade license and a value of the non-volatile rollback counter using a key to generate a digital signature; output the digital signature for transmission to a license server; and limit features of the apparatus based on the downgrade license.

As another example, an apparatus for feature distribution is provided. The apparatus includes: means for obtaining a downgrade license for a set of features for an apparatus, wherein the downgrade license enables fewer features as compared to a previous license; means for incrementing a non-volatile rollback counter based on the downgrade license; means for digitally signing the downgrade license and a value of the non-volatile rollback counter using a key to generate a digital signature; means for outputting the digital signature for transmission to a license server; and means for limiting features of the apparatus based on the downgrade license.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an example of a network that techniques for a rollback secure accountable revocation of features may operate across, in accordance with aspects of the present disclosure;

FIG. 2 illustrates an example implementation of a system-on-a-chip (SoC), in accordance with aspects of the present disclosure;

FIG. 3 is a block diagram illustrating a technique for a rollback-secure accountable revocation of features, in accordance with aspects of the present disclosure;

FIG. 4 is a block diagram illustrating a technique for a rollback-secure accountable revocation of features for multiple subsystems, in accordance with aspects of the present disclosure;

FIG. 5 is a signal diagram illustrating signals of a technique for a rollback-secure accountable revocation of features, in accordance with aspects of the present disclosure;

FIG. 6 is a signal diagram illustrating signals for a permissioned update, in accordance with aspects of the present disclosure;

FIG. 7 is a flow diagram illustrating a process for asset distribution, in accordance with aspects of the present disclosure; and

FIG. 8 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Disclosed are systems and techniques for features distribution, such as for dynamically enabling or disabling features of an electronic device (or component thereof). For example, a device may include a processor with different clock rates that may be enabled or disabled, a radio with different bands which may be enabled or disabled, how much memory may be used, and the like. As a further example, a device component may include a set of features, not all of which may be enabled by an OEM or end user. In some cases, features of the electronic device (or component thereof) may be initially enabled and later dynamically disabled. For example, the OEM may purchase a single type of device component with multiple features and incorporate that device component into multiple OEM product lines which are differentiated by enabling or disabling (e.g., not using, not enabling) certain features of the device component. As another example, a user obtained device may have an initial trial period during which certain features are activated and these features may be deactivated after the trial period unless purchased by the user. In cases where the OEM has purchased a license to all of the features, fees for features that are deactivated may be issued as a rebate to the OEM.

Systems, apparatuses, processes (also referred to as methods), and computer-readable media (collectively referred to as “systems and techniques”) are described herein for providing systems and techniques for a rollback secure accountable revocation of features. For example, the systems and techniques described herein may use different licenses to enable or disable features of a device or device component in a way that avoids reuse of a previously valid license after a reduced features (e.g., downgrade) license is used. A license may be a data structure that includes a listing of the features that are activated for the device (e.g., features that can be performed by the device) and the downgrade license may be any license which does not include a feature (e.g., has fewer features) that was present in a previous license. As an example, a device component may initially have a full-featured license installed. This full-featured license may be used, for example, for testing by an OEM, to enable a trial period for the features for a user, and the like. This full-featured license may later be downgraded to a limited-feature license (e.g., downgrade license) where certain features are disabled. In some cases, the OEM may receive a rebate based on the disabled/downgraded features. The device may check the installed license during use (e.g., during device start, when access to a feature is requested, etc.) and permit use of the feature based on the license.

When an indication to enable or disable features of a device component (e.g., subsystem), such as a downgrade request, is received, the features (e.g., set of features) to be disabled or enabled may be checked against currently enabled features. If the downgrade request would disable a feature that is currently enabled, a downgrade license may be generated and a rollback counter may be incremented. In some cases, the downgrade request may be received from another device, such as a SoC manufacturer (e.g., a license server, OEM system, etc.). For example, the device may receive a feature license, and the feature license may include information about a hierarchy of licenses indicating that the received feature license is a downgrade license. In some cases, the hierarchy may also indicate whether there is a rebate tied to the downgrade (e.g., a rebate eligible downgrade). The rollback counter may be a counter that is incremented each time some action is performed, such as when a license is downgraded. In some cases, the rollback counter may be stored in a non-volatile memory, such as a set of electronic fuses (eFuses), as a non-volatile downgrade license. The eFuses may be incremented by blowing an eFuse of the set of eFuses. In some cases, the rollback counter may be incremented when a downgrade tied to a rebate is to be performed. The downgrade license and a value of the rollback counter (e.g., number of eFuses blown) may be signed as a digital signature using a key of the device. This digital signature may be transmitted to a license server. The license server may be associated with a manufacturer of the component being downgraded. The license server may verify the digital signature with a manufacture of the device and/or component (e.g., OEM, SoC manufacturer, component manufacturer, other partner/manufacturer issuing/associated with the rebate, etc.) and if the digital signature is valid, then the manufacturer of the component may issue a rebate to the OEM.

In some cases, the key of the device may be a symmetrical key that is provided to the device and/or component. The symmetrical key may be provisioned to the device as a part of manufacturing the device and/or component (e.g., by the OEM, SoC manufacturer, component manufacturer, other partner/manufacturer, etc.). In some cases, the key of the device may be an asymmetrical key, such as a private key/public key pair. The private key/public key pair may be provided to the device as a part of provisioning the device by the OEM, or the device may generate the private key/public key pair. Where the device generates the private key/public key pair, the device may provide the public key to the OEM. In some cases, where a private key/public key is used as the key, the digital signature may attest to the license configuration of the device/device component.

Various aspects of the application will be described with respect to the figures.

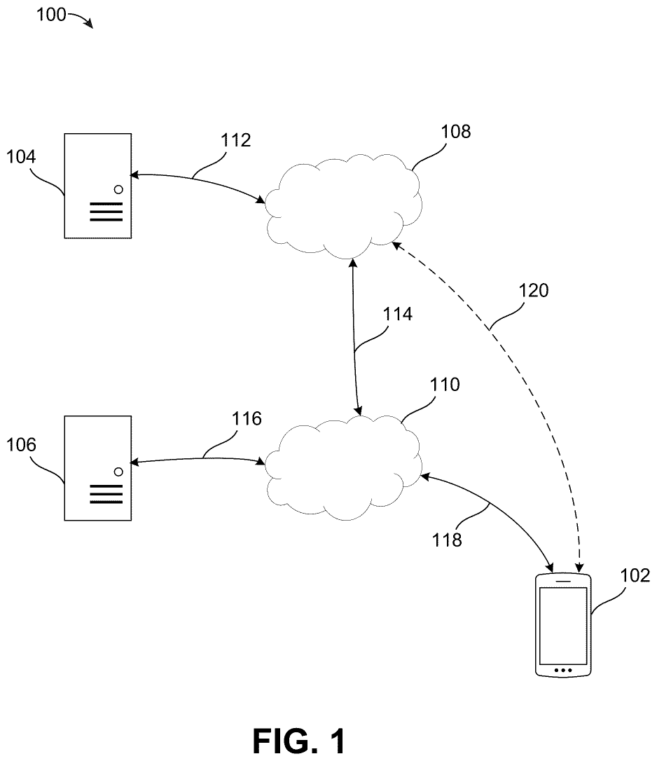

FIG. 1 illustrates an example of a network 100 that techniques for a rollback secure accountable revocation of features may operate across, in accordance with aspects of the present disclosure. The network 100 includes a device 102, a wide area server 104, and a local area server 106. The wide area server 104 is coupled to a wide area network 108 (e.g., the internet) via the link 112. The wide area server 104 may also be coupled to the device 102 via link 120. The wide area network 108 is further coupled to a local area network 110 via the link 114. The local area network 110 is coupled to the local area server 106 via the link 116 and is also coupled to the device 102 via the link 118.

The wide area network 108 may include any combination of wired and/or wireless networks that allows content to be delivered over a wide area. For example, the wide area network 108 may deliver content to a county or state, multiple states, or an entire country. The communication links 112 and 114 comprise any suitable communication links, such as wired and/or wireless links, that operate to allow content (e.g., files, data streams, documents, etc.) to be transmitted from the server 104 to the network 108 and the network 110.

The local area network 110 comprises any combination of wired and/or wireless networks that allows content to be delivered over a local area. For example, the local area network 110 may deliver content to a house, company, neighborhood, city, or county. The local area server 106 communicates with the local area network 110 via the link 116. The link 116 comprises any suitable type of wired or wireless link that allows content to be transmitted from the local area server 106 over the local area network 110.

The device 102 may be a mobile device that communicates with the local area network 110 via the link 118. The device 102 may also communicate with the wide area network 108 via link 120. It should be noted that other devices are possible within the scope of the embodiments. For example, other devices suitable for use in one or more embodiments of the content insertion system comprise a personal digital assistant (PDA), email device, pager, a notebook computer, wired device, desktop computer, workstation, etc. The device 102 may access (e.g., download, stream, render, display, etc.) content received from the servers 104, 106. For example, the device 102 may receive one or more content streams (or channels) for rendering on the device 102. As another example, the device 102 may receive data, documents, or other files that may be accessed by the device 102.

In some cases, the servers 104, 106 operate to deliver content to device 102. For example, the servers 104, 106 may store documents, files, or other content (e.g., data streams, logs, etc.) and operates to deliver this content to the device 102 across the wide area network 108 or local area network 110. The server 104 and server 106 may be the same device or separate devices. The wide area server 104 may deliver content via the wide area network 108 to the device 102 via any of links 120, 114, or 118. The local area server 106 may deliver content via the local area network 110 and link 118.

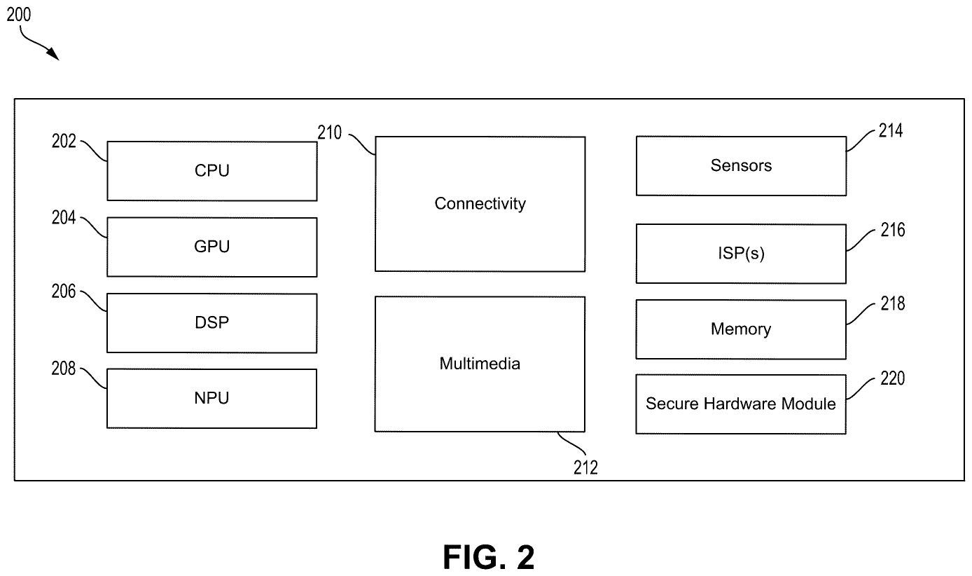

FIG. 2 illustrates an example implementation of a system-on-a-chip (SoC) 200, which may include a central processing unit (CPU) 202 or a multi-core CPU, configured to perform one or more of the functions described herein. In some cases, the SoC 200 may be included as a part of any of the device 102, server 104, and/or server 106 of FIG. 1. Parameters or variables (e.g., neural signals and synaptic weights), system parameters associated with a computational device (e.g., neural network with weights), delays, frequency bin information, task information, among other information may be stored in a memory block associated with a neural processing unit (NPU) 208, in a memory block associated with a CPU 202, in a memory block associated with a graphics processing unit (GPU) 204, in a memory block associated with a digital signal processor (DSP) 206, in a memory block 218, and/or may be distributed across multiple blocks. Instructions executed at the CPU 202 may be loaded from a program memory associated with the CPU 202 or may be loaded from a memory block 218.

In some cases, the SoC 200 may be based on an ARM instruction set. The SoC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, DSP 206, and/or GPU 204. The SoC 200 may also include a sensor processor 214, image signal processors (ISPs) 216, and/or a secure hardware module 220.

The secure hardware module 220 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), trusted platform module (TPM), etc. The secure hardware module 220 may be used to process and/or store sensitive data in an environment that is segregated from the rich execution environment in which the operating system and/or applications may be executed. The secure hardware module 220 can be configured to execute trusted applications that provide end-to-end security for sensitive data by enforcing confidentiality, integrity, and protection of the sensitive data stored therein. The secure hardware module 220 can be used to store encryption keys, access tokens, and other sensitive data. In some cases, the secure hardware module 220 may serve as a root of trust (RoT) for the SoC 200. The RoT may be a hardware or software component that is inherently trusted and/or is a foundation for security for the SoC 200. For example, the secure hardware module 220 may provide for the secure generation of cryptographic keys, limitations on the use of such cryptographic keys, and may contain one or more cryptographic keys or elements that may be used to authenticate the SoC 200. In some cases, the RoT may serve to anchor a chain of trust to validate other hardware and/or software. In some cases, the secure hardware module 220 may be implemented as a secure area of the CPU 202, as a part of the SoC 200, or any combination thereof.

Traditionally, an SoC may be designed monolithically with fixed set of components etched onto a silicon chip. Some recent SoC designs use a chiplet based architecture. A chiplet may be integrated circuit block, a functional circuit block, or other like circuit block specifically designed to work with other chiplets to form a larger, more complex system, such as an SoC. In the chiplet based architecture, the SoC may be designed using a set of chiplet that may be mixed and matched in a modular manner. For example, a chiplet may have a well-defined set of functionalities and can be combined with other chiplets (e.g., having other set(s) of functionality) using an interposer into a single package. Different packages can be constructed by using different combinations of chiplets. Additionally, chiplets may be independently fabricated and then combined together into a package of chiplets at a later manufacturing stage for integration into a system, such as an SoC. An SoC may have any number of packages of chiplets.

It may be useful to allow an OEM (e.g., reseller, device manufacturer, component integrator, etc.) to purchase a single version of a device component, such as a system on chip (SoC), radio, processor, etc. The device component may implement a certain set of features and the OEM may select whether to enable or disable certain features. This provides increased flexibility to the OEM as the OEM may be able to integrate the device component into multiple devices which have different features enabled. Additionally, the OEM may not be able to accurately forecast in advance how many of the multiple devices will be sold and it may be easier to pay a single amount upfront for all of the features of the device component and then obtain a refund for the features that are disabled. Further, as the OEM may control the devices, the OEM may be able to adjust the features (e.g., enable/disable features) of the device component after sale, such as though a device update provided by the OEM. Additionally, a user may be able to adjust features of the device component after a sale of the device. In some cases, after the features of the device component are set (e.g., configured), the device may not be able to verify the enabled/disabled features online (e.g., via a cloud service) as the network may not be always available and the device component manufacturer may not want to/not practicable to provide a cloud service to periodically verify/reverify device features are enabled/disabled.

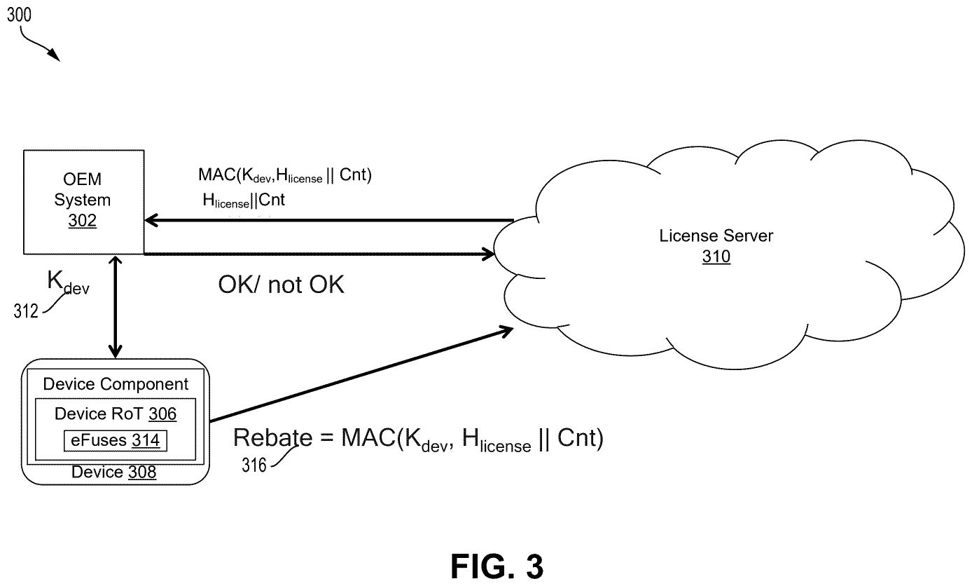

FIG. 3 is a block diagram illustrating a technique for a rollback-secure accountable revocation of features 300, in accordance with aspects of the present disclosure. FIG. 3 includes operations as between an OEM system 302, a device RoT 306 (e.g., secure hardware module 220 of FIG. 2) and device component 304 of a device 308, and a license server 310 (e.g., cloud server(s) operated by a party associated with the device component (e.g., manufacturer, designer, licensor, etc.)). The device 308 includes the device component 304 and the device ROT 306. In FIG. 3, the device component 304 includes the device RoT 306, but it should be understood that the device component 304 may be separate from the device RoT 306. The device RoT 306 may include a set of eFuses 314. In some examples, eFuses 314 operate such that current will flow through an unblown eFuse, but the current will not flow through a blown eFuse (e.g., because the conductor material in the eFuse has failed). Such operation allows a single eFuse to store 1 bit of information (e.g., a 1 or a 0). For instance, an unblown eFuse can represent a value of 0 and a blown eFuse can represent a value of 1. Blowing an eFuse is a one-time operation as, once blown, an eFuse cannot be unblown. The device RoT 306 may have a limited number of eFuses 314.

In some cases, the OEM system 302 may provision the device RoT 306 with a key 312 (K_{dev}). In some cases, the key 312 may be a symmetric key or an asymmetric key (e.g., a public key or private key of a public key/private key pair). Alternatively, the device RoT 306 may generate a private key/public key pair and the OEM system 302 may obtain the public key (e.g., device RoT 306 may provide the public key, OEM system 302 extracts the public key, etc.). In some cases, the OEM system 302 may initially configure the device 308 to use all of the features of the device component 304. For example, the OEM system 302 may use a trial license to allow all of the features to be enabled, for example, for device component 304 testing by the OEM system 302, to enable a trial period for an end user, etc.

The OEM system 302 may provision the device 308 with this trial license, or the device RoT 306 may generate the trial license based on the features that are enabled. In some cases, the device RoT 306 may generate a digital signature (MAC) based on the trial license and a number of blown eFuses 314 using the key 312. In some cases, the digital signature may be generated by a remote server, such as the license server 310 or OEM system 302. The device RoT 306 may verify the digital signature for a feature set indicated by the license based on, for example, usage of features of the device component 304 (e.g., on boot, before use, etc.). For example, the digital signature may be signed using a private key of the device 308 based on the license and number of blown eFuses 314 and the device RoT 306 may verify the digital signature by verifying the digital signature using the private key of the device 308 and the number of blown eFuses 314. Features of the device component 304 may then be limited based on the license. In cases where the digital signature may be signed using a private key of the device 308, the device 308 may transmit a public key corresponding to the private key to the OEM system 302.

The OEM, or an end user, may downgrade the device component 304 to disable one or more features that was previously enabled (e.g., currently enabled features). For example, the OEM may perform a downgrade on the device component 304 as a part of manufacturing the device 308. As another example, after a trial period a user which has purchased/obtained the device 308 may downgrade the device 308 (e.g., by not renewing a subscription, selecting a service tier, not activating/deactivating/disabling/etc. a feature, etc.). An indication to deactivate one or more features may be received, for example, by the device RoT 306. The device RoT 306 may generate a downgrade license based on the indication to deactivate one or more features (e.g., the set of features enabled after one or more features are deactivated/disabled) for the device component 304. In some cases, the device RoT 306 may indicate to a server, such as a license server 310 or OEM system 302, which features should be enabled, and the server may generate a license and send the license to the device RoT 306. In some cases, the license may include a data structure, such as a bitmap, indicating which features are enabled or disabled. The device RoT 306 may secure the device component 304 against potential replay attacks by a non-volatile rollback counter. In some cases, eFuses may be used as a non-volatile rollback counter. For example, device RoT 306 may include a set of eFuses 314. When a new license (H_{License}) is created, for example, by the device RoT 306 or license engine that is a downgrade compared to a previous license, the device RoT 306 may blow an eFuse of the eFuses 314 as a downgrade counter.

Blowing the eFuse on downgrade invalidates a previous license (e.g., the trial license) and prevents a rollback attack by replaying a previously used license which included more enabled features as compared to the new (downgraded) license. In some cases, each license may indicate the features enabled under the license and determining whether one license is a downgrade as compared to another may be a comparison of what features are enabled by the licenses. Blowing the eFuse changes the number of blown eFuses 314 (Cnt) and a previous digital signature can no longer be verified as the number of blown eFuses 314 is different as compared to when the previous license was valid. The device RoT 306 may blow an eFuse when a feature downgrade is performed, but not when a feature upgrade is performed to help conserve the limited number of eFuses 314 available. For example, when an upgrade is performed, the device 308 may communicate with an upgrade server (e.g., license server 310, OEM system 302, another server, etc.) and a license to upgraded features (e.g., newly enabled features) or new license may be provided by the upgrade server.

In some cases, the device 308 may transmit downgrade information 316 to the license server 310. For example, downgrade information 316 may be transmitted to the license server 310 to obtain a rebate for disabled features, to end a subscription to a feature, etc. In some cases, the downgrade information 316 may include the digital signature generated based on the downgrade license, key, and number of blown eFuses 314. In some cases, the downgrade information 316 may also include the number of blown eFuses 314, an identifier for the device 308, and/or information about the downgrade license.

The license server 310 may receive the downgrade information 316 and verify the digital signature using the OEM system 302 (or other similar system from a SoC manufacturer, component manufacturer, other partner/manufacturer, etc.). The license server 310 may send the digital signature to the OEM system 302 along with information about the downgrade license and the number of blown eFuses 314, if available. Based on the received information about the downgrade license and number of blown eFuses 314, the OEM system 302 may verify the digital signature for the device 308. For example, where the key is a symmetric key, the OEM system 302 may verify the digital signature by applying the symmetric key to the downgrade license and count number and comparing a result to the digital signature. As another example, where the key is an asymmetric private key/public key, the digital signature may be generated using the private key of the device 308. The OEM system 302 may look up the corresponding public key and verify the digital signature by applying the public key to the digital signature to obtain information about the downgrade license and number of blown eFuses 314 and compare the information about the downgrade license and number of blown eFuses 314 to corresponding information received from the license server 310. The OEM system 302 may look up the corresponding key, for example, based on a unique device identifier or based on a certificate chain. In some cases, where a private key/public key is used as the key, the digital signature may attest to the license configuration of the device/device component. After verifying the digital signature, the OEM system 302 may respond to the license server 310 indicating whether the digital signature was valid. If the OEM system 302 indicates that the digital signature is valid, the license server 310 may process the rebate/end of subscription, etc.

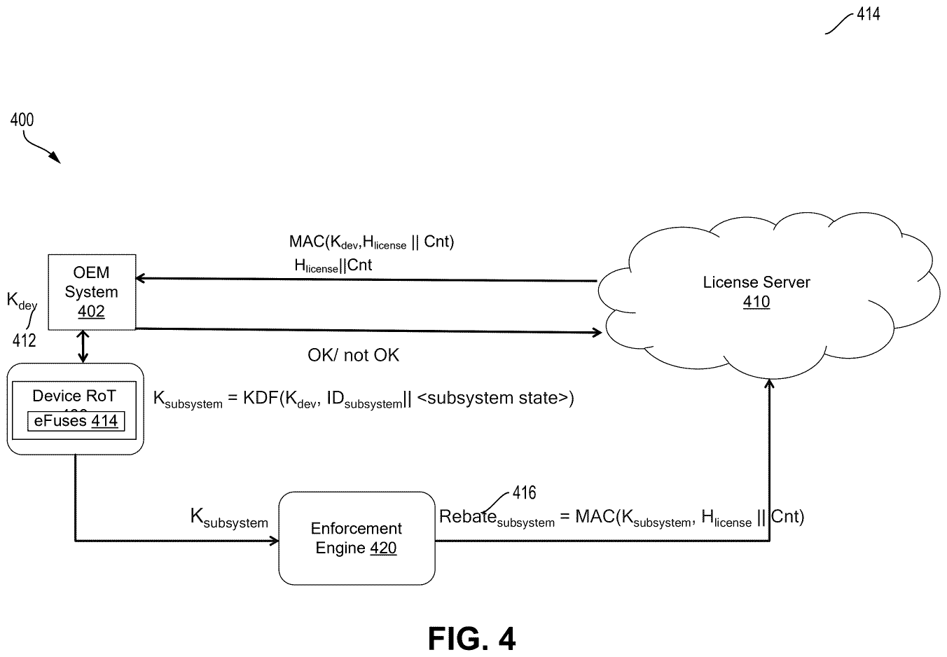

FIG. 4 is a block diagram illustrating a technique for a rollback-secure accountable revocation of features 400 for multiple subsystems, in accordance with aspects of the present disclosure. FIG. 4 includes operations between an OEM system 402, device RoT 406, enforcement engine 420, and license server 410. The OEM system 402 may be substantially similar to OEM system 302 of FIG. 3. The device RoT 406 may be substantially similar to device RoT 306 of FIG. 3. The license server 410 may be substantially similar to license server 310 of FIG. 3. In some cases, the device RoT 406 and enforcement engine 420 may be included in a device (not shown). The device RoT 406 may include a set of eFuses 414. The eFuses 414 may be substantially similar to eFuses 314 of FIG. 3.

In some cases, the device may include multiple subsystems (e.g., as a part of a device component or multiple device components) that include features that may be enabled or disabled based on a license. For example, the device may include a processor with different clock rates that may be enabled or disabled, and a radio with different bands which may be enabled or disabled. The subsystems with features that may be enabled or disabled may have separate keys which may be used to verify whether a feature is enabled or disabled by a license. In such cases, the OEM system 402 (or other similar system from a SoC manufacturer, component manufacturer, other partner/manufacturer, etc.) may provision the device RoT 406 with a key 412 (K_{dev}) in a manner substantially similar to that discussed above with respect to FIG. 3. The device RoT 406 may be used to derive subsystems keys (K_{subsystem}) using a key derivation formula (KDF) based on the key 412 and an identifier of the subsystem a key is being derived for. For example, the subsystems may be provisioned with a subsystem identifier identifying the subsystem as a part of manufacturing the subsystem. The KDF may be a cryptographic algorithm that generates one or more keys based on an input key. In some cases, a subsystem state may also be input to the KDF to derive the subsystem key. The subsystem state may be a binary string indicating the security properties of the subsystem, such as whether debug access or secure boot access are enabled. In some cases, the subsystem state may be verified to check that the subsystem is not in an unsecure, debug, and/or development mode. Separate subsystem keys may be derived for each subsystem. In some cases, where a downgrade is performed, the RoT 406 may generate a downgrade license (H_{License}) in a manner substantially similar to that discussed above with respect to FIG. 3. The RoT 406 may pass the downgrade license to the enforcement engine 420. When a downgrade license (H_{License}) is created, the device RoT 406 may blow an eFuse of the eFuses 414 as a downgrade counter in a manner substantially similar to that discussed above with respect to FIG. 3.

In some cases, digital signatures (MAC) may be generated per subsystem and the enforcement engine 420 may obtain an appropriate subsystem key (K_{subsystem}), the downgrade license, and a number of blown eFuses 314 (Cnt) from the device RoT 406 to generate a digital signature for the subsystem. In some cases, the device RoT 406 maybe be configured to execute relatively simple applications and it may not be suitable to generate digital signatures per subsystem directly using the device RoT 406. In such cases, the enforcement engine 420 may be used to generate the per subsystem digital signatures on downgrade. In some cases, the enforcement engine 420 may execute in a lower security region of a processor as compared to the device RoT 406, such as a trusted execution environment, or applications processor.

In some cases, the per subsystem digital signature may be based on the subsystem key (K_{subsystem}), the downgrade license, and a number of blown eFuses 414 (Cnt). In some cases, per subsystem digital signatures may be generated for each subsystem having license configurable features (e.g., features that may be enabled/disabled by a license) per downgrade by the enforcement engine 420. The enforcement engine 420 may transmit the per subsystem digital signatures to the license server 410 as downgrade information 416. In some cases, the downgrade information 416 may also include the number of blown eFuses 414, an identifier for the device, information about the downgrade license, and/or an indication of a subsystem corresponding to the downgrade license.

The license server 410 may receive the downgrade information 416 and verify the digital signature using the OEM system 402. The license server 410 may send a symmetric MAC or asymmetric signature to the OEM system 302 along with number of blown eFuses 414, an identifier for the device, information about the downgrade license, and/or an indication of a subsystem corresponding to the downgrade license, if available. Based on the received downgrade information 416, the OEM system 402 may verify the digital signature for the subsystems of the device 308 in a manner substantially similar to that discussed above with respect to FIG. 3. After verifying the digital signature, the OEM system 402 may respond to the license server 410 indicating whether the per subsystem digital signatures were valid. If the OEM system 402 indicates that the per subsystem digital signatures are valid, the license server 410 may process the rebate/end of subscription, etc.

In some cases where a symmetric key is used, the MAC may be evidence of a downgrade for the license server 410. For example, as the MAC may be determined based on the license, number of blown fuses, etc., successful decoding of the MAC using the symmetric key provides the license and indicates that the device with which the symmetric key was shared with was downgraded.

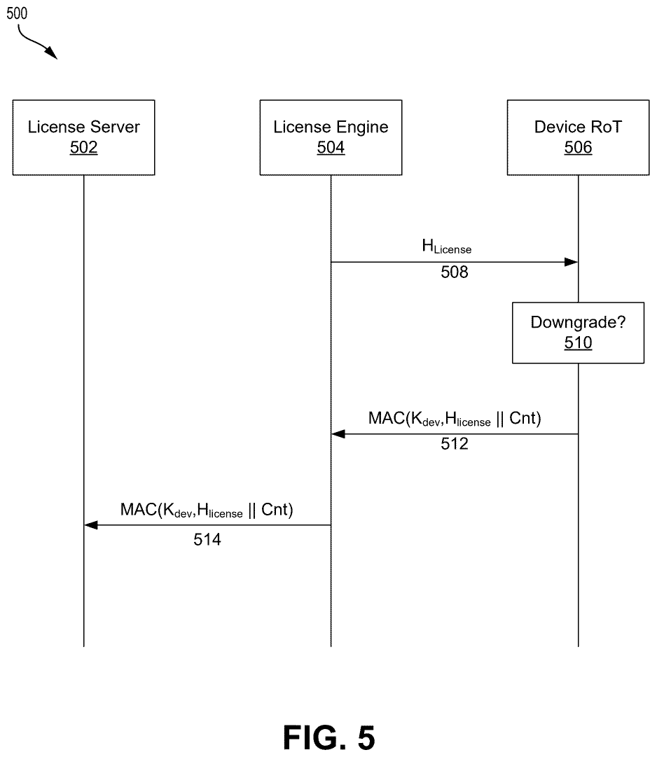

FIG. 5 is a signal diagram 500 illustrating signals of a technique for a rollback-secure accountable revocation of features, in accordance with aspects of the present disclosure. Signal diagram 500 illustrates signals as between a license server 502, a license engine 504 of a device, and a device RoT 506 of the device. The license server 502 may correspond with license server 310 of FIG. 3 and/or license server 410 of FIG. 4. The device RoT 506 may correspond with device RoT 306 of FIG. 3 and/or device RoT 406 of FIG. 4. In FIG. 5, where a downgrade is performed, the license engine 504 may generate a downgrade license (H_{License}) based on the set of features enabled after the downgrade. In some cases, the license engine 504 may facilitate license generation and may communicate with the license server. The license engine 504 may execute in a lower security region of a processor as compared to the device RoT 506, such as a trusted execution environment, or applications processor. In some cases, the downgrade license may be signed, for example, by a SoC vendor. The signature may be used to determine, for example, license hierarchies, for example, where it is difficult to determine if one license is a downgrade of another, such as where a hardware feature is disabled, but another software feature is enabled to compensate. For example, the signature may indicate that the signed license is a downgrade license. The license engine 504 may transmit 508 the downgrade license to the device RoT 506 to install the downgrade license in the device RoT 506 for use in verifying which features are enabled for device components and/or subsystems of the device.

The device RoT 506 may receive the downgrade license and verify whether the downgrade license is performing a downgrade 510. If the downgrade license is performing a downgrade 510, the device RoT 506 may increment the downgrade counter (e.g., by blowing an eFuse) to invalidate previous licenses. The device RoT 506 (or enforcement engine) may determine a digital signature (MAC) for the downgrade license based on the incremented downgrade counter, key, and downgrade license in a manner substantially similar to that discussed above with respect to FIG. 3. The device RoT 506 may then send 512 the digital signature to the license engine 504. The license engine 504 may then forward the digital signature to the license server 502 for verification in a manner substantially similar to that discussed above with respect to FIG. 3.

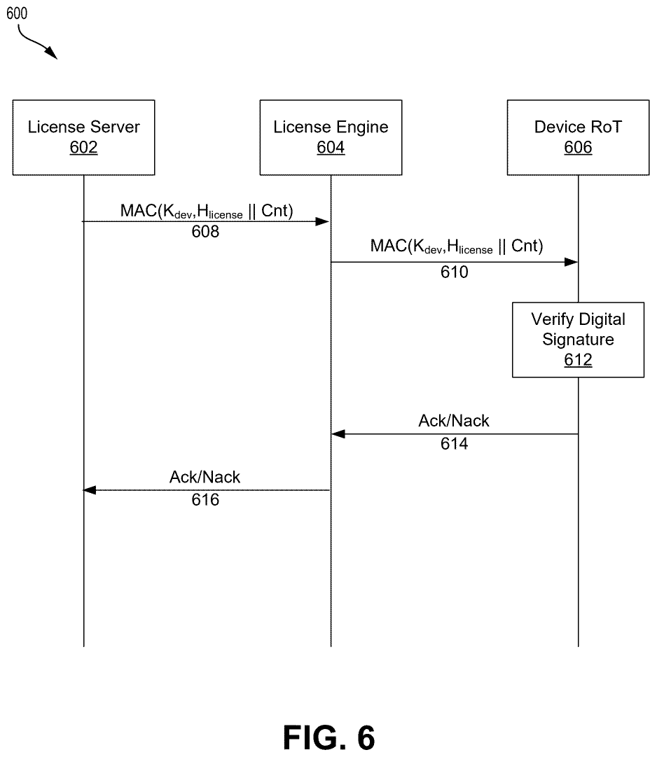

FIG. 6 is a signal diagram 600 illustrating signals for a permissioned update, in accordance with aspects of the present disclosure. Signal diagram 600 illustrates signals as between a license server 602, a license engine 604 of a device, and a device RoT 606 of the device. The license server 502 may correspond with license server 310 of FIG. 3, license server 410 of FIG. 4, and/or license server 502 of FIG. 5. The device RoT 606 may correspond with device RoT 306 of FIG. 3, device RoT 406 of FIG. 4, and/or device RoT 506 of FIG. 5. In some cases, a permissioned update may be initiated by the license server 602 to perform an upgrade for license configurable features to enable one or more features of the device. For example, the license server 602 may have received and stored the number of blown eFuses (Cnt) for the device as a part of a previous feature downgrade. The license server 602 may also obtain a key K_{dev} associated with the device (e.g., symmetrical key or asymmetrical key). In some cases, the license server 602 may obtain the key from the SoC manufacturer (e.g., OEM system 302), or the license server may verify or generate digital signatures (MAC) based on a request to the service that includes the key. The license server may generate an upgrade license (H_{License}) and generate the digital signature (MAC) based on the upgrade license, number of blown eFuses, and key. The license server 602 may transmit 608 the digital signature to the license engine 604 of the device. In some cases, the upgrade license may be a license that activates a feature that was previously disabled by a previous license (e.g., includes one or more features not included in a previous license). Where a symmetric key is used, the license server may store the MAC as an indication of the features activated for a particular device. In some cases, such as for a system recovery, the license server may send a MAC to the device to indicate a current features set to restore the device.

The license engine 604 may forward 610 the digital signature to the device RoT 606, and the device RoT 606 may verify 612 the digital signature based on the key and number of blown fuses for the device. After verification, the device RoT 606 may install the license and transmit an acknowledgment 614 and/or indication that the license was accepted to the license engine 604. If the digital signature is not verified, then the device RoT 606 may transmit a negative acknowledgment 614 and/or indication that the license was not accepted to the license engine 604. The license engine 604 may forward the acknowledgment/negative acknowledgement 614 to the license server 602.

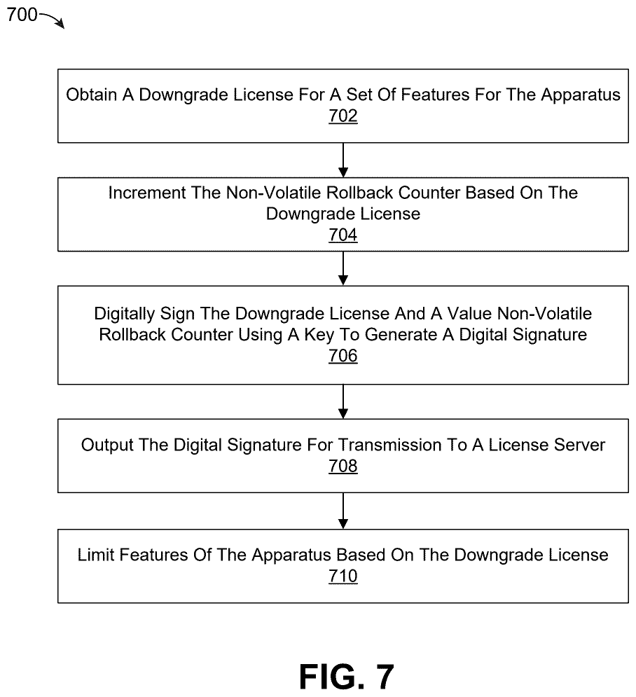

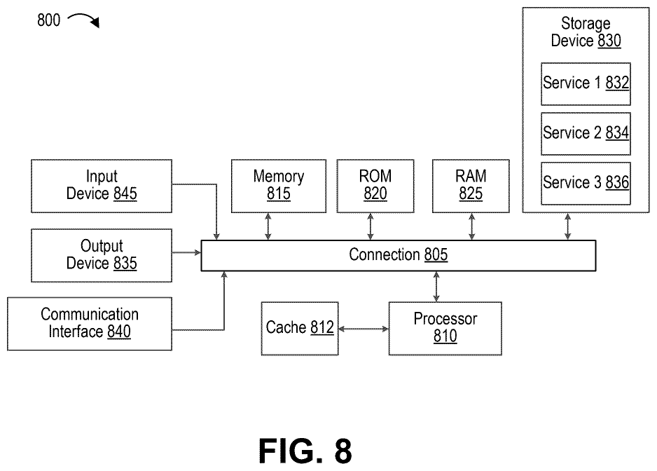

FIG. 7 is a flow diagram illustrating a process 700 for asset distribution, in accordance with aspects of the present disclosure. The process 700 may be performed by a computing device (e.g., apparatus, device 102 of FIG. 1, SoC 200 of FIG. 2, device 308 of FIG. 3, computing system 800 of FIG. 8, etc.) or a component (e.g., a chipset, codec, etc., such as a CPU 202 of FIG. 2, secure hardware module 220 of FIG. 2, device component 304 of FIG. 3, device RoT 306 of FIG. 3, device RoT 406 of FIG. 4, processor 810 of FIG. 8, etc.) of the computing device. The computing device may be a mobile device (e.g., a mobile phone), a network-connected wearable such as a watch, an extended reality (XR) device such as a virtual reality (VR) device or augmented reality (AR) device, a laptop computer, desktop computer, tablet, vehicle or component or system of a vehicle, or other type of computing device. The operations of the process 700 may be implemented as software components that are executed and run on one or more processors (e.g., processor 810 of FIG. 8, and/or other processor(s)). In some cases, the operations of the process 700 can be implemented by a system having the architecture of computing system 800 of FIG. 8.

At block 702, the computing device (or component thereof) may obtain a downgrade license for a set of features for the apparatus. In some cases, the downgrade license does not include a feature included in a previous license (e.g., trial license, current license, etc.). In some cases, the computing device (or component thereof) may determine the downgrade license does not include the feature included in the previous license by comparing features enabled or disabled by the downgrade license to features enabled or disabled by the previous license. In some cases, the digital signature may indicate whether the license is a downgrade license. In some examples, the set of features is determined based on an indication to deactivate a feature. This indication to deactivate a feature may be received, for example, from a user. In some cases, the computing device (or component thereof) may receive the downgrade license from a server.

At block 704, the computing device (or component thereof) may increment the non-volatile rollback counter based on the downgrade license. In some cases, the non-volatile rollback counter may be used to secure the computing device against potential replay attacks. In some examples, the non-volatile rollback counter comprises a set of fuses (e.g., eFuses 314 of FIG. 3, eFuses 414 of FIG. 4, etc.), and wherein, to increment the non-volatile rollback counter, the at least one processor is configured to blow a fuse of the set of fuses. In some cases, the computing device (or component thereof) may include a root of trust (e.g., device RoT 306 of FIG. 3, device RoT 406 of FIG. 4, device RoT 506 of FIG. 5, etc.), the non-volatile rollback counter is incremented by the root of trust, and the downgrade license and value of the non-volatile rollback counter are signed by the root of trust.

At block 706, the computing device (or component thereof) may digitally sign the downgrade license and a value of the non-volatile rollback counter using a key (e.g., key 312 of FIG. 3) to generate a digital signature (e.g., MAC). In some cases, the value of the non-volatile rollback counter may be based on a number of fuses blown of the set of fuses. In some examples, the key comprises a symmetrical key provisioned to the apparatus. In some cases, the symmetrical key is provisioned to the apparatus as a part of manufacturing the apparatus. In some examples, the key comprises a private key provisioned to the apparatus as a part of manufacturing the apparatus. In some cases, the key comprises a private key generated by the apparatus, and wherein the at least one processor is further configured to transmit a public key corresponding to the private key to a manufacturer of the apparatus. In some examples, the key is generated using a key derivation formula based on an identifier for a subsystem of the apparatus. In some cases, the identifier for the subsystem is provisioned to the subsystem. For example, the identifier for the subsystem may be provisioned as a part of manufacturing the subsystem. In some examples, the key comprises a symmetrical key, and wherein the digital signature comprises evidence of a downgrade for the license server.

At block 708, the computing device (or component thereof) may output the digital signature for transmission to a license server (e.g., license server 310 of FIG. 3, license server 410 of FIG. 4, license server 502 of FIG. 5, etc.). For example, a digital signature generated based on the downgrade license, key, and non-volatile rollback counter value may be included in downgrade information (e.g., downgrade information 316 of FIG. 3) transmitted to a server.

At block 710, the computing device (or component thereof) may limit features of the apparatus based on the downgrade license. In some cases, the computing device (or component thereof) may receive a digitally signed upgrade license, the digitally signed upgrade license including a received value for the non-volatile rollback counter; verify the digitally signed upgrade license based on the key; verify the received value for the non-volatile rollback counter with a current value for the non-volatile rollback counter; and limit features of the apparatus based on the upgrade license. In some cases, the upgrade license includes one or more features not included in a previous license. In some examples, the computing device (or component thereof) may receive the digital signature from the license server; and activate one or more features based on the digital signature without incrementing the non-volatile rollback counter.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, camera, accelerometers, gyroscopes, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some examples, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination oThe, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:
Aspect 1. An apparatus for feature distribution, the apparatus comprising: at least one memory; a non-volatile rollback counter; and at least one processor coupled to the at least one memory, the at least one processor being configured to: obtain a downgrade license for a set of features for the apparatus, wherein the downgrade license does not include a feature included in a previous license; increment the non-volatile rollback counter based on the downgrade license; digitally sign the downgrade license and a value of the non-volatile rollback counter using a key to generate a digital signature; output the digital signature for transmission to a license server; and limit features of the apparatus based on the downgrade license.
Aspect 2. The apparatus of Aspect 1, wherein the non-volatile rollback counter comprises a set of fuses, and wherein, to increment the non-volatile rollback counter, the at least one processor is configured to blow a fuse of the set of fuses.
Aspect 3. The apparatus of any of Aspects 1-2, wherein the at least one processor is configured to determine the downgrade license does not include the feature included in the previous license by comparing features enabled or disabled by the downgrade license to features enabled or disabled by the previous license.
Aspect 4. The apparatus of any of Aspects 1-3, wherein the key comprises a symmetrical key provisioned to the apparatus.
Aspect 5. The apparatus of Aspect 4, wherein the symmetrical key is provisioned to the apparatus as a part of manufacturing the apparatus.
Aspect 6. The apparatus of any of Aspects 1-3, wherein the key comprises a private key provisioned to the apparatus as a part of manufacturing the apparatus.
Aspect 7. The apparatus of any of Aspects 1-3, wherein the key comprises a private key generated by the apparatus, and wherein the at least one processor is further configured to transmit a public key corresponding to the private key to a manufacturer of the apparatus.
Aspect 8. The apparatus of any of Aspects 1-3 or 7, wherein the key is generated using a key derivation formula based on an identifier for a subsystem of the apparatus.
Aspect 9. The apparatus of Aspect 8 wherein the identifier for the subsystem is provisioned to the subsystem.
Aspect 10. The apparatus of any of Aspects 1-9, the apparatus further comprising a root of trust, wherein the non-volatile rollback counter is incremented by the root of trust, and wherein the downgrade license and value of the non-volatile rollback counter are signed by the root of trust.
Aspect 11. The apparatus of any of Aspects 1-10, wherein the at least one processor is configured to: receive a digitally signed upgrade license, the digitally signed upgrade license including a received value for the non-volatile rollback counter; verify the digitally signed upgrade license based on the key; verify the received value for the non-volatile rollback counter with a current value for the non-volatile rollback counter; and limit features of the apparatus based on the upgrade license, wherein the upgrade license includes one or more features not included in a previous license.
Aspect 12. The apparatus of any of Aspects 1-11, wherein the set of features is determined based on an indication to deactivate a feature.
Aspect 13. The apparatus of any of Aspects 1-12, wherein the at least one processor is further configured to receive the downgrade license from a server.
Aspect 14. The apparatus of any of Aspects 1-13, wherein the key comprises a symmetrical key, and wherein the digital signature comprises evidence of a downgrade for the license server.
Aspect 15. The apparatus of any of Aspects 1-14, wherein the at least one processor is configured to: receive the digital signature from the license server; and activate one or more features based on the digital signature without incrementing the non-volatile rollback counter.
Aspect 16. A method for feature distribution, comprising: obtaining a downgrade license for a set of features for an apparatus, wherein the downgrade license enables fewer features as compared to a previous license; incrementing a non-volatile rollback counter based on the downgrade license; digitally signing the downgrade license and a value of the non-volatile rollback counter using a key to generate a digital signature; outputting the digital signature for transmission to a license server; and limiting features of the apparatus based on the downgrade license.
Aspect 17. The method of Aspect 16, wherein the non-volatile rollback counter comprises a set of fuses, and wherein incrementing the non-volatile rollback counter comprises blowing a fuse of the set of fuses.
Aspect 18. The method of any of Aspects 16-17, further comprising determining the does not include a feature included in a previous license by comparing features enabled or disabled by the downgrade license to features enabled or disabled by the previous license.
Aspect 19. The method of any of Aspects 16-18, wherein the key comprises a symmetrical key provisioned to the apparatus.
Aspect 20. The method of Aspect 19, wherein the symmetrical key is provisioned to the apparatus as a part of manufacturing the apparatus.
Aspect 21. The method of any of Aspects 16-18, wherein the key comprises a private key provisioned to the apparatus as a part of manufacturing the apparatus.
Aspect 22. The method of any of Aspects 16-18, wherein the key comprises a private key generated by the apparatus, and further comprising transmitting a public key corresponding to the private key to a manufacturer of the apparatus.
Aspect 23. The method of any of Aspects 16-18 or 22, wherein the key is generated using a key derivation formula based on an identifier for a subsystem of the apparatus.
Aspect 24. The method of Aspect 23 wherein the identifier for the subsystem is provisioned to the subsystem.
Aspect 25. The method of any of Aspects 16-24, wherein the non-volatile rollback counter is incremented by a root of trust, and wherein the downgrade license and value of the non-volatile rollback counter are signed by the root of trust.
Aspect 26. The method of any of Aspects 16-25, further comprising: receiving a digitally signed upgrade license, the digitally signed upgrade license including a received value for the non-volatile rollback counter; verifying the digitally signed upgrade license based on the key; verifying the received value for the non-volatile rollback counter with a current value for the non-volatile rollback counter; and limiting features of the apparatus based on the upgrade license, wherein the upgrade license includes one or more features not included in a previous license.
Aspect 27. The method of any of Aspects 16-26, wherein the set of features is determined based on an indication to deactivate a feature.
Aspect 28. The method of any of Aspects 16-27, further comprising receiving the downgrade license from a server.
Aspect 29. The method of any of Aspects 16-28, wherein the key comprises a symmetrical key, and wherein the digital signature comprises evidence of a downgrade for the license server.
Aspect 30. The method of any of Aspects 16-29, further comprising: receiving the digital signature from the license server; and activating one or more features based on the digital signature without incrementing the non-volatile rollback counter.
Aspect 31. A non-transitory computer-readable medium having stored thereon instructions that, when executed by at least one processor, cause the at least one processor to performing one or more of operations according to any of Aspects 16 to 30.
Aspect 32: An apparatus for feature distribution, comprising means for performing one or more of operations according to any of Aspects 16 to 30.

What is claimed is:

1. An apparatus for feature distribution, the apparatus comprising:
at least one memory;
a non-volatile rollback counter; and
at least one processor coupled to the at least one memory, the at least one processor being configured to:
obtain a downgrade license for a set of features for the apparatus, wherein the downgrade license does not include a feature included in a previous license;
increment the non-volatile rollback counter based on the downgrade license;
digitally sign the downgrade license and a value of the non-volatile rollback counter using a key to generate a digital signature;
output the digital signature for transmission to a license server; and
limit features of the apparatus based on the downgrade license.

2. The apparatus of claim 1, wherein the non-volatile rollback counter comprises a set of fuses, and wherein, to increment the non-volatile rollback counter, the at least one processor is configured to blow a fuse of the set of fuses.

3. The apparatus of claim 1, wherein the at least one processor is configured to determine the downgrade license does not include the feature included in the previous license by comparing features enabled or disabled by the downgrade license to features enabled or disabled by the previous license.

4. The apparatus of claim 1, wherein the key comprises a symmetrical key provisioned to the apparatus.

5. The apparatus of claim 4, wherein the symmetrical key is provisioned to the apparatus as a part of manufacturing the apparatus.

6. The apparatus of claim 1, wherein the key comprises a private key provisioned to the apparatus as a part of manufacturing the apparatus.

7. The apparatus of claim 1, wherein the key comprises a private key generated by the apparatus, and wherein the at least one processor is further configured to transmit a public key corresponding to the private key to a manufacturer of the apparatus.

8. The apparatus of claim 1, wherein the key is generated using a key derivation formula based on an identifier for a subsystem of the apparatus.

9. The apparatus of claim 8 wherein the identifier for the subsystem is provisioned to the subsystem.

10. The apparatus of claim 1, the apparatus further comprising a root of trust, wherein the non-volatile rollback counter is incremented by the root of trust, and wherein the downgrade license and value of the non-volatile rollback counter are signed by the root of trust.

11. The apparatus of claim 1, wherein the at least one processor is configured to:
receive a digitally signed upgrade license, the digitally signed upgrade license including a received value for the non-volatile rollback counter;
verify the digitally signed upgrade license based on the key;
verify the received value for the non-volatile rollback counter with a current value for the non-volatile rollback counter; and
limit features of the apparatus based on the upgrade license, wherein the upgrade license includes one or more features not included in a previous license.

12. The apparatus of claim 1, wherein the set of features is determined based on an indication to deactivate a feature.

13. The apparatus of claim 1, wherein the at least one processor is further configured to receive the downgrade license from a server.

14. The apparatus of claim 1, wherein the key comprises a symmetrical key, and wherein the digital signature comprises evidence of a downgrade for the license server.

15. The apparatus of claim 1, wherein the at least one processor is configured to:
receive the digital signature from the license server; and
activate one or more features based on the digital signature without incrementing the non-volatile rollback counter.

16. A method for feature distribution, comprising:
obtaining a downgrade license for a set of features for an apparatus, wherein the downgrade license enables fewer features as compared to a previous license;
incrementing a non-volatile rollback counter based on the downgrade license;
digitally signing the downgrade license and a value of the non-volatile rollback counter using a key to generate a digital signature;
outputting the digital signature for transmission to a license server; and
limiting features of the apparatus based on the downgrade license.

17. The method of claim 16, wherein the non-volatile rollback counter comprises a set of fuses, and wherein incrementing the non-volatile rollback counter comprises blowing a fuse of the set of fuses.

18. The method of claim 16, further comprising determining the downgrade license does not include the feature included in the previous license by comparing features enabled or disabled by the downgrade license to features enabled or disabled by the previous license.

19. The method of claim 16, wherein the key comprises a symmetrical key provisioned to the apparatus.

20. The method of claim 19, wherein the symmetrical key is provisioned to the apparatus as a part of manufacturing the apparatus.
